(19) United States
(12) Patent Application Publication
(10) Pub. No.: US 2012/0032036 A1
(43) Pub. Date: Feb. 9, 2012

(54) PIPE OR CABLE LEAD-THROUGH BLOCKS

(75) Inventors: Jens Andersson, Hasslo (SE); Mats Ericson, Asarum (SE); Jenny Filipsen, Karlskrona (SE); Ulf Hildingsson, Nattraby (SE); Christer Lundborg, Karlskrona (SE); Stefan Milton, Ramdala (SE); Ronnie Pettersson, Jamjo (SE); Jörgen Åkesson, Lyckeby (SE)

(73) Assignee: Roxtec AB, Kalskrona (SE)

(21) Appl. No.: 13/138,154

(22) PCT Filed: Feb. 2, 2010
(86) PCT No.: PCT/SE2010/050118

§ 371 Date: Oct. 5, 2011

(30) Foreign Application Priority Data
Feb. 4, 2009 (SE) 0950039-8

(51) Int. Cl. F16L 3/08

(52) U.S. Cl. 248/74.1

(57) ABSTRACT

Blocks of a cable, wire or pipe transition that may be placed together to form a structure of a number of the blocks. Each block has a generally rectangular shape and forms a part of the cable, wire or pipe transition together with at least one further block. Each block has at least one recess placed in the middle of the block. Inside the recess a number of peelable sheets are received. The sheets may be peeled off to adapt the inner diameter of the block to the outer diameter of a cable, wire or pipe to be received in the recess. Each block has elements for fastening further blocks to the block above or below the block.

### TECHNICAL FIELD

The present invention concerns cable, wire or pipe transitions or lead-through placed in blocks, which blocks may be attached to each other to form different structures. The blocks have peelable sheets for adaption to an outer diameter of a cable, wire or pipe to be received.

### PRIOR ART

The cable, wire or pipe transitions are to receive the cables, wires or pipes in a sealed way.

Cable, wire or pipe transitions are used for sealing in many different environments, such as for cabinets, technical shelters, junction boxes and machines. They are used in different industrial environments, such as automotive, telecom, power generation and distribution, as well as marine and offshore. The transitions often include modules, which may have to seal against fluid, gas, fire, rodents, termites, dust, moisture etc., and may receive cables or wires for electricity, communication, computers etc., pipes for different gases or liquids such as water, compressed air, hydraulic fluid and cooking gas or wires for load retention.

It is previously known to have different types of modules for cable or pipe penetrations. The modules normally made of an elastic material are often placed inside a frame together with some kind of compression means. The compression means is used to compress the modules around respective cable or pipe to give a sealing around the cable or pipe. In some of the modules a package of peelable sheets or layers are arranged in an opening to receive the cable or pipe. By means of the peelable sheets the inner diameter of the opening of the module may be adapted to the outer diameter of the cable or pipe. Thus, the same module may be used for a range of diameters of cables or pipes.

### SUMMARY OF THE INVENTION

The dimensions of openings of walls of different kinds, through which openings cables or pipes are to be lead in a sealed way, may vary. Furthermore the demands of the sealing may vary depending on field of application. One general ambition in all design is to keep the costs for manufacture, storing and transport as low as possible at the same time as the products must fulfil the intended functions.

By having cable or pipe penetrations in form of blocks different wall structures may be formed adapted to the dimensions of a formed opening in a wall of some kind. By means of the present invention a structure may be formed by means of a few standard components, which standard components can be adapted to different dimensions on cables or pipes to be received and different dimensions on an opening receiving the structure. Normally, no outer compression means is used together with the blocks of the present invention. The blocks may be brought together before installation inside a frame or the like, whereby the blocks are placed inside the frame as one single unit. This facilitates installation.

According to the present invention a block having a generally rectangular shape is arranged. The block forms a cable or pipe transition for one or more cables or pipes together with at least one further block. Each block has at least one recess placed in the middle of one side of the block and extended all of the thickness of the block. A number of peelable sheets are placed in the recess. Inside of the peelable sheets a cable or pipe is to be received. The block has means for fastening it to a further block placed above or below the block.

Further objects and advantages of the present invention will be obvious to a person skilled in the art reading the detailed description below of at present preferred embodiments.

### BRIEF DESCRIPTION OF THE DRAWINGS

The invention will be described further below by way of example and with reference to the enclosed drawings. In the drawings:

FIG. 1 is a perspective view of a structure wall formed of a number of blocks according to the present invention,

FIG. 2 is a perspective view from above of one example of a block according to the present invention,

FIG. 3 is a perspective view from below of the block of FIG. 2,

FIG. 4 is a perspective view from above of a further example of a block according to the present invention,

FIG. 5 is a perspective view from below of a still a further example of a block according to the present invention,

FIG. 6 is an end view of the block of FIG. 5,

FIG. 7 is a perspective view from above of a further example of a block according to the present invention,

FIG. 8 is a perspective view of a one example of a frame to be used with blocks according to the present invention, and

FIGS. 9-12 are perspective views of yet further examples of blocks according to the present invention.

### DETAILED DESCRIPTION OF PREFERRED EMBODIMENTS

As used in this description and for ease of description the expressions “upper”, “lower”, “top”, “bottom” and similar expressions are normally in view of the Figs. referred to, or in view of the normal orientation at use. However, a person skilled in the art realises that the blocks of the present invention may have any orientation at use. As used in this description the terms “height”, “width” and “thickness” are used in connection with the blocks and the formed wall in directions as indicated with h, w and t, respectively, in FIG. 2.

By means of a number of blocks 1, 2, 3 according to the present invention it is possible to form different wall structures having a number of cable, wire or pipe transitions.

In one embodiment the blocks 1, 2, 3 are of three general types. One upper block 1 and one lower block 2 is to be placed at the top and bottom, respectively, of the formed structure. Between the upper and lower blocks 1, 2 one or more layers of intermediate blocks 3 are placed in the structure. The blocks 1, 2, 3 are normally made of a relatively rigid polymeric material. In some embodiments the blocks 1, 2, 3 are made of a relatively elastic polymeric material.

The upper block 1 of FIGS. 2 and 3 has a generally rectangular shape. In the middle of the lower surface of the upper block 1, two central semicircular recesses, as seen in cross section, are formed receiving a number of peelable sheets 4 or layers. The semicircular recesses extend all of the thickness of the upper block 1. A person skilled in the art realises that even though the shown recesses have a semicircular cross section form, it is also possible with other cross section forms of the recesses. The upper surface of the upper block 1 is even. On the lower side of the upper block 1 a number of openings 5 are placed for co-operation with protruding parts in the form of bosses 6 of a block placed below the upper block 1 in use.

The lower block 2 of FIG. 4 has a generally rectangular shape. In the middle of the upper surface of the lower block 2, two semicircular recesses are formed receiving a number of peelable sheets 4 or layers. The semicircular recesses extend all of the thickness of the lower block 2. On the upper surface of the lower block 2 a number of protruding parts or bosses 6 are formed. The bosses 6 are to co-operate with openings 5 of one or more blocks placed above the lower block in use, to hold the blocks together. Normally, the lower surface of the lower block 2 is an even continuous surface, having no openings.

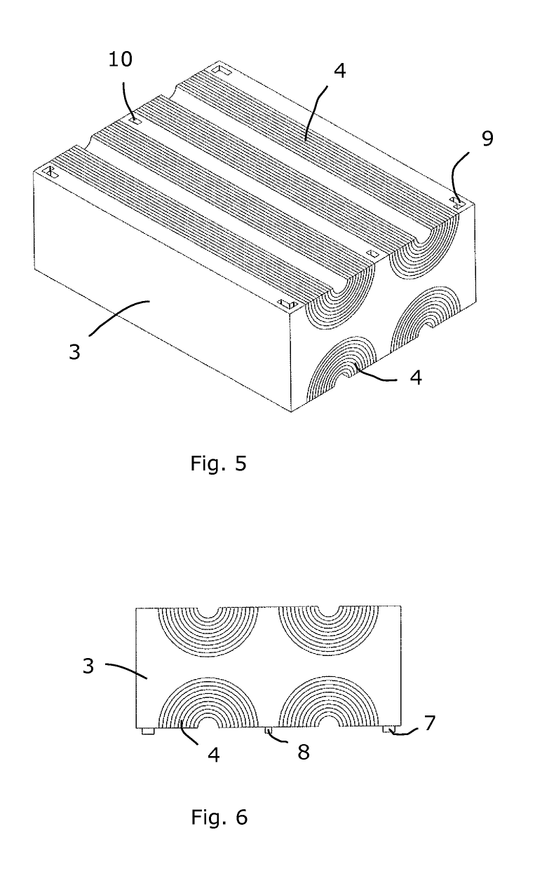

When used with the upper and lower blocks 1, 2 of FIGS. 2-4, the intermediate blocks 3 have bosses and openings for co-operation with the openings 5 and bosses 6 of the upper blocks 1 and lower blocks 2, respectively. The intermediate block 3 of FIGS. 5 and 6 has a generally rectangular shape. In the middle of each of the lower and upper surfaces, respectively, of the intermediate block 3, semicircular recesses are formed receiving a number of peelable sheets 4 or layers. The semicircular recesses extend all of the thickness of the block 3.

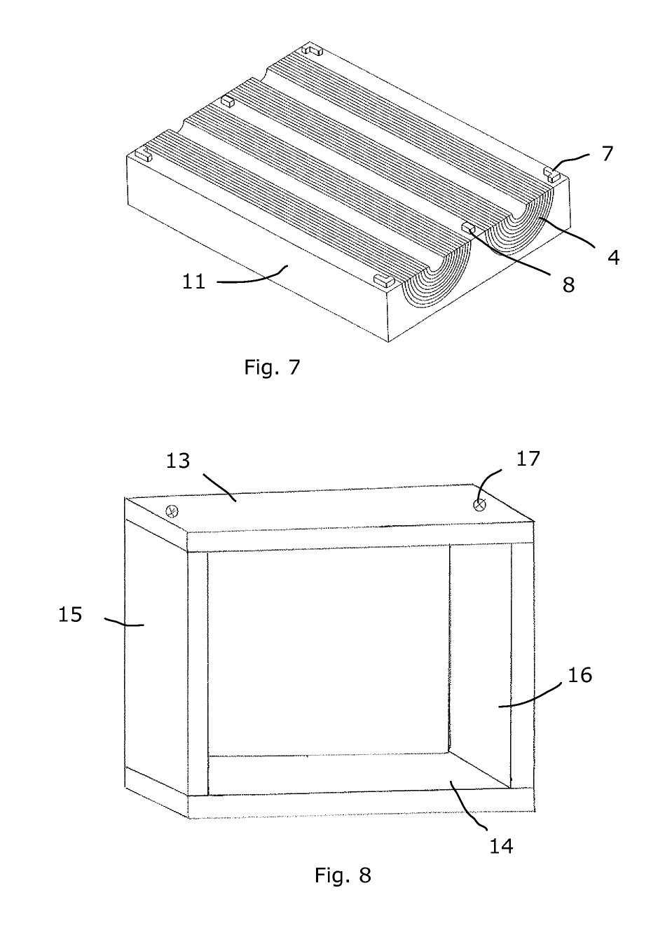

In the embodiments of FIGS. 5, 6 and 7 an alternative form of the parts connecting the different blocks 3, 11 are shown. On the upper surface of the blocks 3, 11 a number of protruding parts 7, 8 are formed and on the lower surface of the blocks 3, 11 a number of corresponding openings 9, 10 are formed. The protruding parts 7, 8 and openings 9, 10 are to co-operate with openings 9, 10 and protruding parts 7, 8, respectively, of blocks placed in a layer above or below the shown blocks 3, 11.

In the embodiment of FIGS. 5-7 the protruding parts 7 at the corners each has two straight parts forming a right angle, thus, the protruding parts 7 and corresponding openings 9 show an L-form in plan view. On two opposite sides of each block further protruding parts 8 are arranged between the protruding parts 7 at the corners. Said further protruding parts 8 are to be received in corresponding openings 10 at a block to be placed above the block having the further protruding parts 8. Said further protruding parts 8 and corresponding openings 10 have only one straight part. The protruding parts 7, 8 of a first block are to be received in openings 9, 10 of a second block placed on top of the first block.

A person skilled in the art realises that the connection between blocks placed on top of each other may be accomplished in many different ways. For instance the protruding parts and corresponding openings may have other forms than shown.

All protruding parts on one block and corresponding co-operating parts or openings of an adjacent block have complementary forms, independently of the exact form of the protruding parts and co-operating parts. The protruding parts are received in a tight fit in the co-operating parts. Thus, the blocks are held together by means of the tight fit between the protruding parts and the co-operating parts.

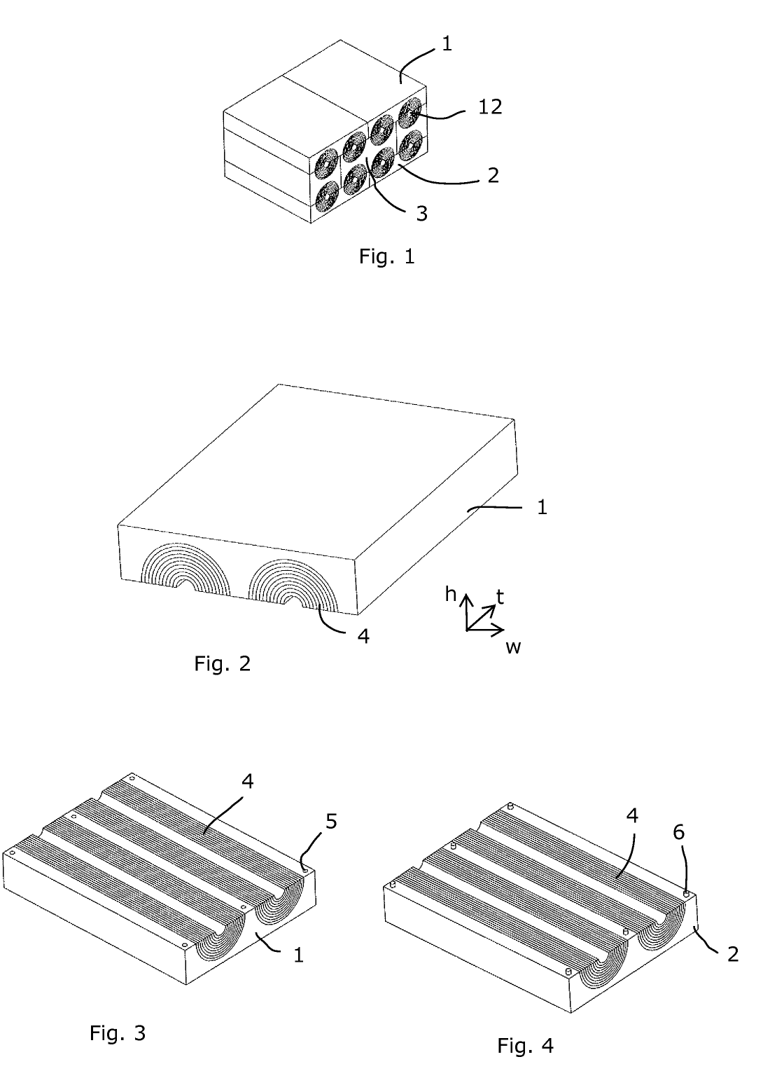

As indicated in FIG. 1 the blocks may have different number of recesses receiving peelable sheets 4. The recesses are evenly distributed on the blocks 1-3, 11. A person skilled in the art realises that the number of recess may vary in principle without limitation. Thus, a block, being an upper, lower or intermediate block, may have one, two, three, four, five etc. recesses on one surface.

By the co-operation through the tight fit between the bosses 6 and protruding parts 7, 8, respectively, and openings 5, 9, 10 of different blocks 1-3, 11, the blocks 1-3, 11 are held together forming a wall structure. By placing a number of blocks 1-3, 11 mutually adjacent each other and above each other a wall structure may be formed, comprising vertical and horizontal rows of blocks 1-3, 11.

The blocks 1-3, 11 used to form a single wall structure should each have the same height and thickness but may have different widths as indicated above. To form a stable wall structure it is beneficial if blocks of different widths are used in such a way that contact surfaces between two separate blocks 1-3, 11 are not placed on a continuous vertical line going through all of the formed wall structure. Such a continuous non-interrupted vertical line will give rows of blocks 1-3, 11 that are not attached to adjacent rows of blocks 1-3, 11.

The blocks 1-3, 11 may have further features in other embodiments as shown in the simultaneously filed applications entitled “A pipe or Cable Lead-Through having a Part Indicating Compression”, “A Module of a Pipe or Cable Lead-Through having Grooves on Opposite Sides”, “Modules of Pipe or Cable Lead-Through Sticking Together”, “A Pipe or Cable Lead-Through having Modularized Modules”, “A Pipe or Cable Lead-Through having Penetrateable Modules”, “Lubrication of a Pipe or Cable Lead-Through” and “A Pipe or Cable Lead-Through having Modules with a Dimensioning Function”, filed by the applicant of the present application. These applications are hereby incorporated by reference.

The semicircular recesses of the blocks are placed in such a way that when blocks are put together to form a wall, circular recesses are formed of two semicircular recesses of blocks 1-3, 11 placed on top of each other. In the middle of the peelable sheets 4 of each circular recess a blind 12 is placed. The blinds 12 are normally fixed by adhesive to the peelable sheets 4 on either the upper or lower sides of each block 1-3, 11. The blind 12 is taken away when a cable or pipe is to be received in the recess. The recess may be placed eccentrically in the same way as shown in the simultaneously filed application entitled “Eccentric Part of a Pipe or cable Lead-Through”, filed by the applicant of the present application. This application is hereby incorporated by reference.

The sheets 4 of each block adhere enough to each other to stick together but at the same time loose enough to be peeled off by hand. The same goes for the blinds 12. Normally the sheets 4 are peeled off one by one but it is also possible to peel off a larger number of sheets 4 at the time. The sheets 4 are made of an elastic polymeric material.

The sheets may be arranged in many different ways and with different features as reflected in the simultaneously filed applications entitled “A pipe or Cable Lead-Through having Interconnected Layers”, “A Pipe or Cable Lead-Through having Layers of Different Thickness”, “Cohering Between Layers of a Pipe or Cable Lead-Through” and “Identification of Layers of a Pipe or Cable Lead-Through”, filed by the applicant of the present application. These applications are hereby incorporated by reference.

The structure formed may have any number of blocks but must always have at least two blocks.

Often the structure of blocks 1-3, 11 is received inside a frame or the like holding the structure in position and possibly compressing the structure. The tightness of the structure will be improved by compressing. In FIG. 8 one example of a frame is shown, which frame may be used together with the structure of blocks 1-3, 11. The frame has an upper horizontal frame beam 13, a lower horizontal frame beam 14, a left vertical frame beam 15 and a right vertical frame beam 16. The stated positions of the different frame beams 13-16 are with reference to FIG. 8. A person skilled in the art realises that the frame may be mounted in other positions than as showed in FIG. 8. The upper horizontal frame beam 12 has two through openings at the ends. The trough openings are to receive one fixation screw 17 each. The fixation screws 17 go into one vertical frame beam 15, 16 each. In a corresponding way the lower horizontal frame beam has two through openings receiving fixation screws, which go into one vertical frame beam 15, 16 each. A structure of blocks is to be placed inside the frame formed of the upper horizontal frame beam 13, the lower horizontal frame beam 14, the left vertical frame beam 15 and the right vertical frame beam 16. The dimension of the frame may be altered, by replacing the horizontal and/or vertical frame beams 13-16 with frame beams of other lengths. In some embodiments (not shown) the blocks adjacent the frame are connected to the frame by means of co-operating protruding parts and openings. Thus, such blocks are connected to the frame in a similar way to the connection between the blocks.

In a further embodiment one or more of the horizontal and/or the vertical frame beams are received movable in relation to the other parts of the frame, thereby the inner dimension of the frame may be varied in a simple way.

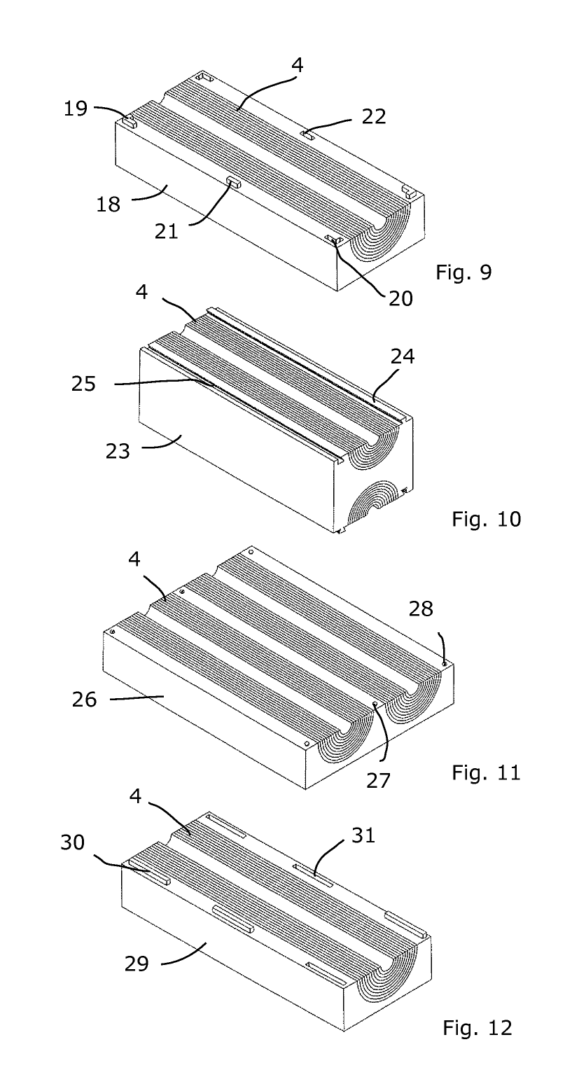

In FIGS. 9-12 further examples of connection between the blocks are shown. A person skilled in the art realises that the exact form of the co-operating parts forming the mutual connection between the blocks may be varied in many ways and that the shown connecting parts may be combined in many different ways. For several of the shown examples the upper and lower blocks are identical. This is achieved in that the blocks are provided with alternating bosses and groves.

In the example of FIG. 9 a block 18 is shown. A number of peelable sheets 4 are placed in a semicylindrical recess of the block 18. The block 18 has protruding parts 19 having an L-form in two diagonally opposite corners and two L-formed openings 20 at the other two corners. Between the protruding parts 19 and openings 20, respectively, at the corners further protruding parts 21 and openings 22 are placed outside the recess holding the peelable sheets 4. These latter protruding parts 21 and openings 22 have an elongated form.

The block 23 shown in FIG. 10 has a protruding part in the form of a rail 24 and a co-operating part in the form of a groove 25 on two opposing sides, which rails 24 and grooves 25 extend across the block 23 in the thickness direction t. The rails 24 and grooves 25 are placed outside a semicylindrical recess receiving a number of peelable sheets 4. The rails 24 and grooves 25 have corresponding cross sections in form of a dovetail. By means of the dovetails two blocks 23 may be held together firmly in the height h direction of the blocks. Two connected blocks 23 are to be slid in relation to each other to connect or disconnect them. A person skilled in the art realises that it is possible to achieve them same effect with rails and grooves of many different cross section forms.

The block 26 of FIG. 11 has protruding parts or bosses 27 and openings 28 corresponding with the bosses 5 and openings 6 of the blocks 1, 2 shown in FIGS. 3 and 4. However, in the embodiment of FIG. 11 the block 26 has alternating bosses 27 and openings 28 on the same side of the block 26.

The block 29 of FIG. 12 differs from the block 20 of FIG. 9 only in the form of the protruding parts 30 and the openings 31. In the block 29 of FIG. 12 the protruding parts 30 and the openings 31 all have an elongated form.

Also in the embodiments of FIGS. 9-12 the protruding parts and co-operating parts have complementary forms and are held together in a tight fit.

A person skilled in the art realises that the different connection forms shown in FIGS. 9-12 also could be used in possible connection between blocks and a frame.

In use a cable or pipe may be placed in each circular recess of the structure. If the number of cables or pipes to be received is less than the available recesses the blinds 12 of the recesses not used are kept in place. When a cable or pipe is to be received in a recess, the blocks 1-3, 11, forming said recess, are separated. Then the blind 12 is taken out and an appropriate number of sheets 4 are peeled off from respective block 1-3, 11. The number of sheets 4 peeled off should give an opening normally having an inner diameter being slightly smaller than the outer diameter of the cable or pipe received. As the sheets 4 are made of an elastic material the difference in diameter will be taken up by the sheets 4 remaining in respective block 1-3, 11. In some embodiments the blocks 1-3, 11 are made of an elastic material taking up the difference in diameter. The number of blocks 1-3, 11 used to form a structure of blocks is adapted to the size of an opening in which the structure of blocks is to be received. When all cables or pipes have been placed in the appropriate recesses the blocks are put together to form the structure of blocks, such as a wall. The formed structure of blocks is then pressed into the opening, whereby a tight lead-through is formed for the cables and/or pipes. The structure of blocks 1-3, 11 may be compressed somewhat at installation due to the elasticity of the peelable sheets 4 of the recesses of the blocks 1-3, 11 or the elasticity of the blocks 1-3, 11.

If the structure of blocks 1-3, 11 is to be received inside a frame of the type shown in FIG. 8, horizontal and vertical frame beams 13-16 of appropriate dimensions are chosen. The length of the horizontal frame beams 13, 14 is adapted to the width of the formed structure of blocks 1-3, 11 and the length of the vertical frame beams 15, 16 is adapted to the height of the formed structure of blocks 1-3, 11. When the structure of blocks 1-3, 11 has been placed inside the frame the fixation screws 17 are tightened in order to compress the structure of blocks 1-3, 11. As indicated above the peelable sheets 4 of each block 1-3, 11 are elastic and a compression given by means of the fixation screws 17 of the frame will enhance the tightening of the cable and/or pipe lead-throughs.

1. A block having a generally rectangular shape, which block is part of a cable or pipe transition for one or more cables or pipes together with at least one further block, the block comprising:
at least one recess placed on one side of the block and extended all of the thickness of the block,
a number of peelable sheets in the at least one recess, inside of which peelable sheets a cable or pipe is to be received, and
protruding parts for fastening the block to the at least one further block when placed above or below the block, wherein the at least one further block includes co-operating parts, and wherein the protruding parts and the cooperating parts have complementary forms, and the protruding parts are received in a tight fit in the co-operating parts.

2. The block of claim 1, wherein the at least one recess has a semicircular cross section form.

3. The block of claim 1, wherein a number of protruding parts at one block co-operates with openings at another block, to fasten two blocks to each other.

4. The block of claim 3, wherein the protruding parts are placed at corners of the one block and the openings are placed at corners of the other block and each of the protruding parts and openings has two straight parts forming a right angle, giving the protruding parts and openings an L-form in plan view, and wherein the protruding parts and corresponding openings placed between the protruding parts and the openings respectively, at the corners have an elongated form.

5. The block of claim 3, wherein the protruding parts and the openings have an elongated form.

6. The block of claim 1, wherein the protruding parts are rails on one block and the co-operating grooves are of another block, which rails and grooves extends all of the thickness of the block.

7. The block of claim 6, wherein the rails and the grooves have a dovetail form in cross section.

8. The block of claim 1, wherein the recesses receiving the number of peelable sheets is on opposing sides of the block and wherein the peelable sheets adhere to each other loose enough for separate sheets to be peeled off by hand.

9. A lead-through block structure, comprising: plurality of blocks according to claim 1 placed mutually adjacent to each other and on top of each other.

10. The lead-through block structure of claim 9, further comprising a frame and the structure is inside the frame.

11. The lead-through block structure of claim 10, wherein the frame is formed of an upper horizontal frame beam, a lower horizontal frame beam, a left vertical frame beam and a right vertical frame beam.

12. The lead-through block structure of claim 11, wherein the frame beams are fixed to each other by fixation screws.

13. The lead-through block structure of claim 11, wherein at least one of the horizontal and the vertical frame beams are received movable in relation to the other frame beams of the frame.

14. The lead-through block structure of claim 9, wherein at least one block has a different width than the other blocks, whereby the blocks are placed in such that contact surfaces between two separate blocks are not placed on a continuous vertical line going through all of the formed structure.
